(19) United States
(12) Patent Application Publication
(10) Pub. No.: US 2024/0284951 A1
(43) Pub. Date: Aug. 29, 2024

(54) ACID LIQUID SEASONING

(71) Applicant: KEWPIE CORPORATION, Tokyo (JP)

(72) Inventors: Riho IWAMI, Tokyo (JP); Hideaki KOBAYASHI, Tokyo (JP); Hidehiko YAMAMOTO, Tokyo (JP)

(21) Appl. No.: 18/294,357

(22) PCT Filed: Mar. 30, 2022
(86) PCT No.: PCT/JP2022/016072

§ 371 Date: Feb. 1, 2024

(30) Foreign Application Priority Data
Aug. 20, 2021 (JP) 2021-135013

(51) Int. Cl. A23L 27/00; A23D 7/005; A23L 27/20; A23L 27/60

(52) U.S. Cl. CPC A23L 27/80; A23D 7/0053; A23L 27/2028; A23L 27/60; A23L 27/82

(57) ABSTRACT

An acid liquid seasoning includes at least acetic acid, an edible oil and fat, and water, and at least a part of the acid liquid seasoning includes an emulsified phase. In the acid liquid seasoning, the content of the acetic acid is 0.1% by mass or more and 3.0% by mass or less with respect to the total amount of an aqueous phase, the content of the edible oil and fat is 10% by mass or more with respect to the total amount of the acid liquid seasoning, the edible oil and fat includes unroasted sesame oil, and the ratio of the content of the unroasted sesame oil in the acid liquid seasoning to the content of the acetic acid in the aqueous phase is 0.1 or more and 10 or less.

### BACKGROUND OF THE INVENTION

### Field of the Invention

The present invention relates to an acid liquid seasoning, and more specifically relates to an acid liquid seasoning which contains at least acetic acid, an edible oil and fat, and water, and of which at least a part includes an emulsified phase.

### Background Art

Conventionally, liquid seasonings have been blended with various edible oils and fats. In recent years, liquid seasonings blended with edible oils and fats considered to be beneficial to health, such as linseed oil and perilla oil, have been developed in response to the more health-conscious consumers. However, there has been a problem in that the oxidative degradation of the edible oils and fats such as linseed oil and perilla oil is prone to occur, and the flavors of the liquid seasonings are prone to be degraded after preservation thereof.

For the problem described above, a seasoning in a separated liquid state including, in an oil phase, an oil and fat A including 40% by mass or more of α-linolenic acid as a fatty acid included in linseed oil, perilla oil, perilla actual oil, or the like, one or two or more oils and fats B selected from, rape oil, soybean oil, and corn oil, and sesame oil, at a specific mass ratio, in order to suppress the degradation of the flavors even after the preservation has been proposed (see Patent Literature 1).

### CITATION LIST

### Patent Literature

[Patent Literature 1] Japanese Patent Laid-Open No. 2017-121214

### SUMMARY OF THE INVENTION

### Technical Problem

However, a liquid seasoning having an emulsified phase has had a problem in that a flavor is prone to be blurred in comparison with a seasoning in a separated liquid state. It is also conceivable that a quality keeping agent or the like is added in order to maintain the sharpness of the flavor of a seasoning. However, it is also conceivable that a quality keeping agent or the like is added in order to maintain the sharpness of the flavor of a seasoning, there has also been a problem in that the original flavor balance of a seasoning is changed due to the influence of the taste of the additive itself depending on the agent to be added.

The present invention was made in view of the problems described above and is directed at providing an acid liquid seasoning of which the flavor is not blurred and the original flavor can be maintained even after preservation thereof.

### Solution to Problem

As a result of intensive examination, the present inventors surprisingly found that the technological problems described above can be solved by an acid liquid seasoning which includes at least acetic acid, an edible oil and fat, and water, and of which at least a part includes an emulsified phase, wherein unroasted sesame oil is used in at least a part of the edible oil and fat, the content of the acetic acid in an aqueous phase is adjusted, and the ratio of the content of the unroasted sesame oil to the content of the acetic acid in the aqueous phase is further adjusted, and the present invention was thus accomplished.

In other words, in accordance with one aspect of the present invention, there is provided an acid liquid seasoning which includes at least acetic acid, an edible oil and fat, and water, and of which at least a part includes an emulsified phase, wherein a content of the acetic acid is 0.1% by mass or more and 3.0% by mass or less with respect to a total amount of an aqueous phase, a content of the edible oil and fat is 10% by mass or more with respect to a total amount of the acid liquid seasoning, the edible oil and fat include unroasted sesame oil, and a ratio of a content of the unroasted sesame oil in the acid liquid seasoning to the content of the acetic acid in the aqueous phase is 0.1 or more and 10 or less.

In accordance with an aspect of the present invention, it is preferable that the acid liquid seasoning further includes an emulsifying material.

In accordance with an aspect of the present invention, it is preferable that a ratio of the content of the unroasted sesame oil in the acid liquid seasoning to a content of the emulsifying material in the acid liquid seasoning is 0.01 or more and 10 or less.

In accordance with an aspect of the present invention, it is preferable that the emulsifying material is at least one selected from a group consisting of egg yolk and emulsifying starch.

In accordance with an aspect of the present invention, it is preferable that the content of the unroasted sesame oil is 0.1% by mass or more and 15% by mass or less with respect to a total amount of the edible oil and fat.

In accordance with an aspect of the present invention, it is preferable that the content of the edible oil and fat is 80% by mass or less with respect to the total amount of the acid liquid seasoning.

In accordance with an aspect of the present invention, it is preferable that the acid liquid seasoning is a mayonnaise-like seasoning.

### Advantageous Effects of Invention

In accordance with the present invention, there can be provided an acid liquid seasoning of which the flavor is not blurred and the original flavor can be maintained even after preservation thereof. Such an acid liquid seasoning can induce the appetites of consumers and enable the expectation of further development of a market for acid liquid seasonings.

### DETAILED DESCRIPTION OF THE INVENTION

### <Acid Liquid Seasoning>

An acid liquid seasoning of the present invention includes at least acetic acid, an edible oil and fat, and water, and may further include an emulsifying material, another raw material, and the like.

At least a part of the acid liquid seasoning of the present invention includes an emulsified phase. In other words, the whole may be in an emulsification state, a state in which a part of an oil phase slightly floats in an upper portion is acceptable, or a state in which the oil phase is layered on a portion in an emulsification state is acceptable. The emulsification state refers to the state of an oil-in-water type (O/W type) liquid seasoning in which an oil phase is dispersed in oil droplet form in an aqueous phase. Examples of the acid liquid seasoning include mayonnaise-like seasonings, dressings, sauces, bastings, and materials similar thereto, mayonnaise-like seasonings and dressings are preferred, and mayonnaise-like seasonings are further preferred. In “Food Labeling Standard” established by the Consumer Affairs Agency, dressings having a viscosity of 30 Pa·s or more are called semisolid dressings. Among them, a dressing using predetermined raw materials such as egg yolk and having a water content of 30% by mass or less and an oil and fat content of 65% by mass or more is mayonnaise. Mayonnaise-like seasonings in the present invention also include a similar product group which has properties (for example, taste, appearance, main raw material, and the like) similar to those of mayonnaise defined in Food Labeling Standard, and of which the component composition is not compliant with Food Labeling Standard.

### (Amount of Aqueous Phase of Acid Liquid Seasoning)

The amount of the aqueous phase of the acid liquid seasoning is not particularly limited, and can be appropriately set depending on the content of another component. The amount of the aqueous phase of the acid liquid seasoning is preferably 5% by mass or more and 85% by mass or less, and more preferably 10% by mass or more and 80% by mass or less. In particular, when the acid liquid seasoning is a mayonnaise-like seasoning, the amount of the aqueous phase is still more preferably 10% by mass or more and 30% by mass or less. When the acid liquid seasoning is a dressing, the amount of the aqueous phase is still more preferably 50% by mass or more and 80% by mass or less. The amount of the aqueous phase of the acid liquid seasoning is the total amount of components (water, acetic acid, emulsifying material, seasoning, and the like) included in the aqueous phase, and can be calculated by subtracting the amount of the oil phase (edible oil and fat) from the total amount of the acid liquid seasoning.

### (pH of Acid Liquid Seasoning)

The pH of the acid liquid seasoning is preferably 3.0 or more and 4.8 or less, the lower limit value thereof is more preferably 3.3 or more, and still more preferably 3.5 or more, and the upper limit value thereof is more preferably 4.7 or less, and still more preferably 4.6 or less. When the pH of the acid liquid seasoning is within the range described above, the flavor of the acid liquid seasoning can be allowed to be favorable while controlling generation of microorganisms in the acid liquid seasoning to enhance preservability. The value of the pH of the acid liquid seasoning is a value measured using a commercially available pH measurement instrument (for example, desktop type pH meter F-72 manufactured by HORIBA, Ltd.) at a pressure set at one atmosphere and a product temperature set at 20° C.

### (Edible Oil and Fat)

The edible oil and fat used in the acid liquid seasoning includes at least unroasted sesame oil. The unroasted sesame oil is sesame oil obtained by a conventionally known method such as compression or extraction, purification (decolorization or the like), or filtration with neither roasting nor processing sesame seeds as raw materials, and is also commonly called sesame salad oil. In particular, unroasted sesame oil undergoing a decolorization step is more transparent than roasted sesame, and is preferred because of having a little flavor peculiar to sesame. The sesame as the raw material is not particularly limited, and each of white sesame, brown sesame, and black sesame can be used as the sesame. In the present invention, blending of the acid liquid seasoning with the unroasted sesame oil rather than roasted sesame can prevent the original flavor of the seasoning from being influenced, and can further prevent the original flavor of the seasoning from being blurred to maintain the flavor even after preservation thereof.

The edible oil and fat used in the acid liquid seasoning may include an additional edible oil and fat other than the unroasted sesame oil and roasted sesame described above. A conventionally known edible oil and fat can be used as the additional edible oil and fat, which is not particularly limited. Examples of the additional edible oil and fat may include: vegetable oils and fats, such as rape oil, soybean oil, palm oil, cotton seed cake oil, corn oil, sunflower oil, safflower oil, rice oil, linseed oil, perilla oil, camellia oil, grape seed oil, peanut oil, almond oil, and avocado oil; EPA- and DHA-containing oils and fats, such as fish oil and algal oil; and oils and fats obtained by being subjected to chemical or enzymatic treatment or the like, such as hardened oil and interesterified oil. Of these, vegetable oils and fats are preferably used, and rape oil, soybean oil, corn oil, palm oil, or a mixed oil thereof are more preferably used.

### (Content of Edible Oil and Fat)

The ratio of the content of the unroasted sesame oil in the acid liquid seasoning to the content of the acetic acid in the aqueous phase is 0.1 or more and 10 or less, the lower limit value thereof is preferably 0.2 or more, more preferably 0.3 or more, and still more preferably 0.5 or more, and the upper limit value thereof is preferably 8.0 or less, more preferably 6.0 or less, and still more preferably 5.0 or less. When the above-described ratio (content of unroasted sesame oil/content of acetic acid in aqueous phase) is less than the lower limit value or more than the upper limit value, the flavor of the acid liquid seasoning becomes blurred after preservation thereof, and it is impossible to maintain the original flavor thereof. Therefore, the flavor of the acid liquid seasoning is not blurred and the original flavor thereof can be maintained even after the preservation thereof when the above-described ratio is within the numerical range described above.

The ratio of the content of the unroasted sesame oil in the acid liquid seasoning to the content of the emulsifying material in the acid liquid seasoning is preferably 0.01 or more and 10 or less, the lower limit value thereof is more preferably 0.03 or more, still more preferably 0.05 or more, and even more preferably 0.07 or more, and the upper limit value thereof is more preferably 7 or less, still more preferably 5 or less, and even more preferably 1.0 or less. When the above-described ratio (content of unroasted sesame oil/content of emulsifying material) is within the numerical range described above, the flavor of the acid liquid seasoning is not blurred, and the original flavor thereof can be maintained even after preservation thereof.

The content of the edible oil and fat is 10% by mass or more, preferably 30% by mass or more, more preferably 40% by mass or more, and still more preferably 50% by mass or more, and preferably 80% by mass or less, more preferably 75% by mass or less, and still more preferably 70% by mass or less with respect to the total amount of the acid liquid seasoning. When the content of the oil and fat in the acid liquid seasoning is within the numerical range described above, a savory taste derived from the oil can be sufficiently felt.

The content of the unroasted sesame oil is preferably 0.1% by mass or more and 15% by mass or less with respect to the total amount of the edible oil and fat, the lower limit value thereof is more preferably 0.5% by mass or more, and still more preferably 1.0% by mass or more, and the upper limit value thereof is more preferably 14% by mass or less, and still more preferably 13% by mass or less. When the content of unroasted sesame oil with respect to the total amount of the edible oil and fat is within the numerical range described above, the flavor of the acid liquid seasoning is not blurred, and the original flavor thereof can be maintained even after preservation thereof.

### (Acetic Acid)

The pH of the acid liquid seasoning can be adjusted to pH in the preferred numerical range described above by blending the acid liquid seasoning with the acetic acid. The content of the acetic acid is 0.1% by mass or more and 3.0% by mass or less with respect to the total amount of the aqueous phase, the lower limit value thereof is preferably 0.2% by mass or more, and more preferably 0.3% by mass or more, and the upper limit value thereof is preferably 2.5% by mass or less, and more preferably 2.0% by mass or less. When the content of the acetic acid is within the numerical range described above, the flavor of the acid liquid seasoning can be allowed to be favorable while controlling the generation of microorganisms in the acid liquid seasoning to enhance preservability.

### (Acid Material)

The acid liquid seasoning may further include an acid material as well as the acetic acid described above. Examples of the acid material which can be used include: organic acids such as citric acid, malic acid, lactic acid, sorbic acid, benzoic acid, adipic acid, fumaric acid, and succinic acid, and salts thereof; inorganic acids such as phosphoric acid and hydrochloric acid, and salts thereof; and lemon juice, apple juice, orange juice, and lactic acid-fermented milk. Blending of these acid materials enables the pH of the acid liquid seasoning to be adjusted, and enables the flavor of the acid liquid seasoning to be favorable. The content of the acid material other than the acetic acid can be appropriately adjusted depending on the pH of interest and the content of the acetic acid.

### (Emulsifying Material)

The acid liquid seasoning can be blended with an emulsifying material in order to facilitate maintenance of an emulsification state. A conventionally known emulsifying material that is commonly used in a liquid seasoning can be used as the emulsifying material, which is not particularly limited. Examples of the emulsifying material include egg yolk, emulsifying starch, and other emulsifiers (for example, lecithins such as egg yolk lecithin and soybean lecithin, and synthetic emulsifying materials such as polyglycerol fatty acid ester and sucrose fatty acid ester). Of these, egg yolk and/or emulsifying starch are preferably used.

### (Egg Yolk)

Examples of the egg yolk used in the acid liquid seasoning include: liquid egg yolks and raw egg yolks; and egg yolks obtained by subjecting the liquid egg yolks and the raw egg yolks to one or two or more treatments of germicidal treatments, freezing treatments, drying treatments such as spray dry and freeze dry, enzyme treatments with phospholipase A1 or phospholipase A2, such as phospholipase A-treated egg yolk, desugaring treatments with yeast, glucose oxidase, or the like, decholesterolization treatments such as supercritical carbon dioxide treatment, mixing treatments with salt, sugar, or the like, and the like.

The lower limit value of the content of the egg yolk is preferably 0.1% by mass or more, more preferably 1% by mass or more, and still more preferably 5% by mass or more, and the upper limit value thereof is preferably 30% by mass or less, more preferably 25% by mass or less, and still more preferably 20% by mass or less with respect to the total amount of the acid liquid seasoning on a raw basis. The stable emulsification state of the acid liquid seasoning can be maintained even after preservation thereof when the content of the egg yolk in the acid liquid seasoning on a raw basis is within the range described above.

### (Emulsifying Starch)

Processed starch having an emulsification ability can be used as the emulsifying starch used in the acid liquid seasoning. Examples of the emulsifying starch include starches subjected to processing treatment and the like by which the starches are allowed to have emulsification abilities, such as potato starches, maize starch corn starches (for example, corn starches derived from sweet corn, dent corn, and waxy corn), tapioca starches, sago starches, sweet potato starches, wheat starches, and rice starches. Examples of the emulsifying starch include alkenyl succinic acid starches such as sodium starch octenyl succinate. These may be used singly, or in combination of two or more kinds thereof.

The lower limit value of the content of the emulsifying starch is preferably 0.1% by mass or more, more preferably 0.5% by mass or more, and still more preferably 1% by mass or more, and the upper limit value thereof is preferably 15% by mass or less, more preferably 10% by mass or less, and still more preferably 5% by mass or less with respect to the total amount of the acid liquid seasoning. The stable emulsification state of the acid liquid seasoning can be maintained even after preservation thereof when the content of the emulsifying starch in the acid liquid seasoning is within the range described above.

### (Thickener)

The acid liquid seasoning can be blended with a thickener in order to facilitate maintenance of an emulsification state. A gum can be used as the thickener. Examples of the gum include xanthan gum, konjac gum, guar gum, tamarind seed gum, locust bean gum, gellan gum, gum arabic, and the like. These thickeners may be used singly, or in combination of two or more kinds thereof.

The content of the thickener is preferably 0.01% by mass or more, more preferably 0.05% by mass or more, and still more preferably 0.1% by mass or more, and preferably 5% by mass or less, more preferably 1% by mass or less, and still more preferably 0.5% by mass or less with respect to the total amount of the acid liquid seasoning. Maintenance of the emulsification state of the acid liquid seasoning is facilitated when the content of the thickener is within the range described above.

### (Other Raw Materials)

In addition to the raw materials described above, various raw materials that are commonly used in acid liquid seasonings can be appropriately selected and incorporated into the acid liquid seasoning as long as the effects of the present invention are not impaired. Examples thereof include: seasonings such as soy sauce, mirin, salt, sodium glutamate, and bouillon; sugars such as glucose, fructose, sucrose, malt sugar, oligosaccharide, and trehalose; spices such as mustard powder and pepper; antioxidants such as ascorbic acid and vitamin E; and bacteriostatic agents.

### <Method of Producing Acid Liquid Seasoning>

An example of a method of producing the acid liquid seasoning of the present invention is described. For example, first, another aqueous phase raw material such as clear water, vinegar, or a seasoning is mixed to prepare an aqueous phase. Then, an emulsifying material such as egg yolk is added to the prepared aqueous phase. Subsequently, an edible oil and fat as a raw material for an oil phase are poured into the aqueous phase while stirring the aqueous phase with a mixer or the like to emulsify the aqueous phase, whereby the acid liquid seasoning of which at least a part includes an emulsified phase can be obtained.

### (Production Apparatus)

A usual apparatus used in production of an acid liquid seasoning can be used in the production of the acid liquid seasoning of the present invention. Examples of such apparatuses include common stirring machines, stick mixers, stand mixers, homomixers, and homodispersers. Examples of the shapes of the stirring blades of the stirring machines include propeller blades, turbine blades, paddle blades, and anchor blades.

### EXAMPLES

The present invention is described in more detail below with reference to Examples and Comparative Examples, but the present invention is not intended to be interpreted with limitation to the contents of the following Examples.

### <Production Example 1 of Acid Liquid Seasoning (Mayonnaise-Like Seasoning)>

### Example 1

An acid liquid seasoning was produced according to blending rates described in Table 1. Specifically, first, vinegar (acid degree of acetic acid of 4%), sodium glutamate, salt, and clear water were mixed to be homogeneous, to prepare an aqueous phase. Then, raw egg yolk was added to the prepared aqueous phase, unroasted sesame oil (that had been already subjected to decolorization treatment) and soybean oil were then poured into the mixture, and emulsification treatment of the resultant was performed to produce the acid liquid seasoning having an emulsified phase.

### Example 2

An acid liquid seasoning was produced in a manner similar to that in Example 1 except that the content of unroasted sesame oil was changed to 1% by mass, and the content of soybean oil was changed to 69% by mass.

### Example 3

An acid liquid seasoning was produced in a manner similar to that in Example 1 except that the content of unroasted sesame oil was changed to 8% by mass, and the content of soybean oil was changed to 62% by mass.

### Example 4

An acid liquid seasoning was produced in a manner similar to that in Example 1 except that the content of unroasted sesame oil was changed to 10% by mass, and the content of soybean oil was changed to 60% by mass.

### Comparative Example 1

An acid liquid seasoning was produced in a manner similar to that in Example 1 except that unroasted sesame oil was not blended, and the content of soybean oil was changed to 70% by mass.

### Comparative Example 2

An acid liquid seasoning was produced in a manner similar to that in Example 2 except that roasted sesame oil was blended instead of the unroasted sesame oil.

### (pH Measurement)

The pH of each of the acid liquid seasonings described above was measured using a pH measurement instrument (desktop type pH meter F-72 manufactured by HORIBA, Ltd.) at a pressure set at one atmosphere and a product temperature set at 20° C. The pH of each of the acid liquid seasonings was 3.5 or more and 4.6 or less.

### (Sensory Evaluation)

The acid liquid seasonings obtained as described above were subjected to a preservation test at 55° C. for 7 days. Subsequently, each acid liquid seasoning after the preservation thereof was subjected to sensory evaluation for “blurred flavor” and “maintenance of original flavor” by a plurality of trained panels on the basis of the following criteria. The flavor of the acid liquid seasoning of Comparative Example 1 prior to the preservation thereof was set at a score of 4 as a reference. The scores of the evaluation results are set forth in Table 1. A score of 3 or more can be considered to exhibit a favorable result.

### [Evaluation Criteria of Blurred Flavor]

4: A blurred flavor was not felt at all.
3: Almost no blurred flavor was felt.
2: A blurred flavor was felt.
1: A blurred flavor was considerably felt.

### [Evaluation Criteria of Maintenance of Original Flavor]

4: An original flavor balance was very favorable.
3: An original flavor balance was favorable.
2: An original flavor balance was poor.
1: An original flavor balance was very poor.

In each of the acid liquid seasonings of Examples 1 to 4, the flavor of an egg was sufficiently felt, the flavor of the seasoning was not blurred, and the original flavor of the seasoning was sufficiently maintained even after preservation thereof.

In the acid liquid seasoning of Comparative Example 1, unroasted sesame oil was not blended at all, and therefore, the flavor of an egg was not felt, the flavor of the seasoning was blurred, and the original flavor of the seasoning was not able to be maintained after preservation thereof.

In the acid liquid seasoning of Comparative Example 2, the roasted sesame oil was blended instead of the unroasted sesame oil, and therefore, the flavor of an egg was not felt under the influence of the flavor of the sesame oil, the flavor of the seasoning was blurred, and the original flavor of the seasoning was not able to be maintained after preservation thereof.

TABLE 1

| | Example | Example | Example | Example | Comparative | Comparative |
|---|---|---|---|---|---|---|
| Raw material | 1 | 2 | 3 | 4 | Example 1 | Example 2 |
| Vinegar (acid degree | 13.8 | 13.8 | 13.8 | 13.8 | 13.8 | 13.8 |
| of acetic acid of 4%) | | | | | | |
| Egg yolk (on raw | 13.5 | 13.5 | 13.5 | 13.5 | 13.5 | 13.5 |
| basis) | | | | | | |
| Unroasted sesame oil | 0.5 | 1 | 8 | 10 | 0 | 0 |
| Roasted sesame oil | 0 | 0 | 0 | 0 | 0 | 1 |
| Soybean oil | 69.5 | 69 | 62 | 60 | 70 | 69 |
| Sodium glutamate | 0.3 | 0.3 | 0.3 | 0.3 | 0.3 | 0.3 |
| Salt | 0.45 | 0.45 | 0.45 | 0.45 | 0.45 | 0.45 |
| Clear water | Balance | Balance | Balance | Balance | Balance | Balance |
| Total (% by mass) | 100 | 100 | 100 | 100 | 100 | 100 |
| Acetic acid in aqueous | 1.84 | 1.84 | 1.84 | 1.84 | 1.84 | 1.84 |
| phase (%) | | | | | | |
| Unroasted sesame | 0.27 | 0.54 | 4.35 | 5.43 | 0.00 | 0.00 |
| oil/acetic acid in | | | | | | |
| aqueous phase | | | | | | |
| Unroasted sesame | 0.04 | 0.07 | 0.59 | 0.74 | 0.00 | 0.00 |
| oil/emulsifying | | | | | | |
| material | | | | | | |
| Unroasted sesame | 0.7 | 1.4 | 11.4 | 14.3 | 0.0 | 0.0 |
| oil %/edible oil and fat | | | | | | |
| Blurred flavor | 4 | 4 | 4 | 3 | 1 | 1 |
| Maintenance of flavor | 3 | 4 | 4 | 4 | 1 | 1 |

### <Production Example 2 of Acid Liquid Seasoning (Mayonnaise-Like Seasoning)>

### Example 5

An acid liquid seasoning was produced according to blending rates described in Table 2. Specifically, first, vinegar (acid degree of acetic acid of 4%), sodium glutamate, salt, mustard powder, and clear water were mixed to be homogeneous, to prepare an aqueous phase. Then, emulsifying starch (sodium starch octenyl succinate) and processed starch (alfanized starch) were added to the prepared aqueous phase, unroasted sesame oil and soybean oil were then poured into the mixture, and emulsification treatment of the resultant was performed to produce an acid liquid seasoning.

### Comparative Example 3

An acid liquid seasoning was produced in a manner similar to that in Example 5 except that unroasted sesame oil was not blended, and the contents of soybean oil, salt, emulsifying starch, and clear water were changed as described in Table 2.

### (Measurement of pH)

The pHs of the acid liquid seasonings of Example 5 and Comparative Example 3, obtained as described above, were measured in a manner similar to that in <Production Example 1 of Acid Liquid Seasoning> described above. The pH of each of the acid liquid seasonings was 3.5 or more and 4.6 or less.

### (Sensory Evaluation)

Sensory evaluation of each acid liquid seasoning obtained as described above was performed in a manner similar to that in <Production Example 1 of Acid Liquid Seasoning> described above. The scores of the evaluation results are set forth in Table 2. A score of 3 or more can be considered to exhibit a favorable result.

In the acid liquid seasoning of Example 5, fresh sourness was sufficiently felt, the flavor was not blurred, and the original flavor of the seasoning was sufficiently maintained even after preservation thereof.

In the acid liquid seasoning of Comparative Example 3, unroasted sesame oil was not blended at all, and therefore, fresh sourness was not felt at all, the flavor of the seasoning was blurred, and the original flavor of the seasoning was not able to be maintained after preservation thereof. In particular, the offensive oxidative degradation smell of the edible oil and fat was felt in the seasoning after the preservation thereof.

TABLE 2

| | | Comparative |
|---|---|---|
| | Example 5 | Example 3 |
| Vinegar | 13.8 | 13.8 |
| (acid degree of acetic acid of 4%) | | |
| Unroasted sesame oil | 1 | 0 |
| Soybean oil | 69 | 70 |
| Sodium glutamate | 0.3 | 0.3 |
| Salt | 2 | 2 |
| Emulsifying starch | 2.5 | 2.5 |
| Processed starch | 0.2 | 0.2 |
| Mustard powder | 0.2 | 0.2 |
| Clear water | Balance | Balance |
| Total (% by mass) | 100 | 100 |
| Acetic acid in aqueous phase (%) | 1.84 | 1.84 |
| Unroasted sesame oil/ | 0.54 | 0.00 |
| acetic acid in aqueous phase | | |
| Unroasted sesame oil/ | 0.37 | 0.00 |
| emulsifying material | | |
| Unroasted sesame oil %/ | 1.4 | 0.0 |
| edible oil and fat | | |
| Blurred flavor | 3 | 1 |
| Maintenance of flavor | 3 | 1 |

### <Production Example 3 of Acid Liquid Seasoning (Dressing)>

### Example 6

An acid liquid seasoning was produced according to blending rates described in Table 3. Specifically, first, brewed vinegar (acid degree of acetic acid of 4%), xanthan gum, salt, lemon juice, sugar, and clear water were mixed to be homogeneous, to prepare an aqueous phase. Then, raw egg yolk was added to the prepared aqueous phase, unroasted sesame oil and soybean oil were then poured into the mixture, and emulsification treatment of the resultant was performed to produce the acid liquid seasoning.

### Comparative Example 4

An acid liquid seasoning was produced in a manner similar to that in Example 6 except that the contents of unroasted sesame oil, soybean oil, and clear water were changed as described in Table 3.

### (Measurement of pH)

The pHs of the acid liquid seasonings of Example 6 and Comparative Example 4, obtained as described above, were measured in a manner similar to that in <Production Example 1 of Acid Liquid Seasoning> described above. The pH of each of the acid liquid seasonings was 3.5 or more and 4.6 or less.

### (Sensory Evaluation)

Sensory evaluation of each acid liquid seasoning obtained as described above was performed in a manner similar to that in <Production Example 1 of Acid Liquid Seasoning> described above. The scores of the evaluation results are set forth in Table 3. A score of 3 or more can be considered to exhibit a favorable result.

In the acid liquid seasoning of Example 6, the flavor of spice was sufficiently felt, the flavor was not blurred, and the original flavor of the seasoning was sufficiently maintained even after preservation thereof.

In the acid liquid seasoning of Comparative Example 4, the ratio of the content of the unroasted sesame oil to the content of acetic acid in an aqueous phase was too high, and therefore, fresh sourness was not felt at all, the flavor of the seasoning was blurred, and the original flavor of the seasoning was not able to be maintained after preservation thereof. In particular, in the seasoning after the preservation thereof, the offensive oxidative degradation smell of the egg yolk was felt, and an acrid taste was felt as an aftertaste.

TABLE 3

| | | Comparative |
|---|---|---|
| | Example 6 | Example 4 |
| Brewed vinegar | 8.3 | 8.3 |
| (acid degree of acetic acid of 4%) | | |
| Egg yolk (on raw basis) | 0.2 | 0.2 |
| Unroasted sesame oil | 1 | 6 |
| Soybean oil | 9 | 24 |
| Xanthan gum | 0.1 | 0.1 |
| Salt | 3.0 | 3.0 |
| Lemon juice | 0.3 | 0.3 |
| (five-fold concentrated) | | |
| Sugar | 10 | 10 |
| Clear water | Balance | Balance |
| Total (% by mass) | 100 | 100 |
| Acetic acid in aqueous phase (%) | 0.37 | 0.47 |
| Unroasted sesame oil/ | 2.71 | 12.65 |
| acetic acid in aqueous phase | | |
| Unroasted sesame oil/ | 5.56 | 33.33 |
| emulsifying material | | |
| Unroasted sesame oil %/ | 10.0 | 20.0 |
| edible oil and fat | | |
| Blurred flavor | 4 | 1 |
| Maintenance of flavor | 4 | 1 |

1. An acid liquid seasoning which comprises at least acetic acid, an edible oil and fat, an emulsifying material and water, and of which at least a part comprises an emulsified phase, wherein
a content of the acetic acid is 0.1% by mass or more and 3.0% by mass or less with respect to a total amount of an aqueous phase,
a content of the edible oil and fat is 10% by mass or more with respect to a total amount of the acid liquid seasoning,
the edible oil and fat comprise unroasted sesame oil,
a ratio of a content of the unroasted sesame oil in the acid liquid seasoning to the content of the acetic acid in the aqueous phase is 0.1 or more and 10 or less, and
the emulsifying material is at least one selected from a group consisting of egg yolk and emulsifying starch.

2. (canceled)

3. The acid liquid seasoning according to claim 1, wherein
a ratio of the content of the unroasted sesame oil in the acid liquid seasoning to a content of the emulsifying material in the acid liquid seasoning is 0.01 or more and 10 or less.

4. (canceled)

5. The acid liquid seasoning according to claim 1, wherein
the content of the unroasted sesame oil is 0.1% by mass or more and 15% by mass or less with respect to a total amount of the edible oil and fat.

6. The acid liquid seasoning according to claim 1, wherein
the content of the edible oil and fat is 80% by mass or less with respect to the total amount of the acid liquid seasoning.

7. The acid liquid seasoning according to claim 1, wherein the acid liquid seasoning is a mayonnaise-like seasoning.

8. An acid liquid seasoning which comprises at least acetic acid, an edible oil and fat, and water, and of which at least a part comprises an emulsified phase, wherein
a content of the acetic acid is 0.1% by mass or more and 3.0% by mass or less with respect to a total amount of an aqueous phase,
a content of the edible oil and fat is 10% by mass or more with respect to a total amount of the acid liquid seasoning,
the edible oil and fat comprise unroasted sesame oil,
a ratio of a content of the unroasted sesame oil in the acid liquid seasoning to the content of the acetic acid in the aqueous phase is 0.1 or more and 10 or less, and
the content of the unroasted sesame oil is 0.1% by mass or more and 15% by mass or less with respect to a total amount of the edible oil and fat.
